(19) United States
(12) Patent Application Publication
(10) Pub. No.: US 2014/0164097 A1
(43) Pub. Date: Jun. 12, 2014

(54) METHOD AND SYSTEM FOR FACILITATING THE CREATION OF A PRODUCT DATA SET FOR A PRODUCT ON A WEBSITE

(71) Applicant: Sosign Interactif Inc., Montreal (CA)

(72) Inventor: Jonathan Stoikovitch, Montreal (CA)

(21) Appl. No.: 14/097,687

(22) Filed: Dec. 5, 2013

Related U.S. Application Data
(60) Provisional application No. 61/735,781, filed on Dec. 11, 2012.

(51) Int. Cl. G06Q 30/02

(52) U.S. Cl. CPC G06Q 30/0243
USPC 705/14.42

(57) ABSTRACT

A method and apparatus are disclosed, the method for facilitating the creation of a product data set for a product on a website, the method comprising use of a microprocessor for providing an indication of the product; locating a plurality of listings offering at least one of the product and a similar product; locating a plurality of user reviews concerning at least one of the product and a similar product; determining at least one popular listing amongst the plurality of listings located; generating metadata using the determined at least one popular listings and the plurality of user reviews to thereby facilitate the creation of a product data set for the product.

### CROSS-REFERENCE TO RELATED APPLICATION

The present application claims priority on U.S. Provisional Patent Application No. 61/735,781, filed on Dec. 11, 2012, the subject matter of which is incorporated herein by reference.

### FIELD

The invention relates to electronic commerce. More precisely, this invention pertains to a method for facilitating the creation of a product data set for a product on a website.

### BACKGROUND

Being able to properly advertise a product on the Internet is important. It will often make the difference between a success and a failure.

Very often, trial-and-error techniques are used in order to advertise a product. An operator will typically try a given strategy to advertise a product and modify it from time to time in order to make sure it is efficient.

While this may work in cases where very few products are put online, this task may be cumbersome in the case of a marketplace where a large amount of products is advertised.

In fact, the task will be cumbersome because it will require a lot of work from an operator.

There is a need for a method and apparatus that will overcome at least one of the above-identified drawbacks.

Features of the invention will be apparent from review of the disclosure, drawings and description of the invention below.

### BRIEF SUMMARY

According to a broad aspect of the invention, there is provided a method for facilitating the creation of a product data set for a product on a website, the method comprising providing an indication of the product; locating a plurality of listings offering at least one of the product and a similar product; locating a plurality of user reviews concerning at least one of the product and a similar product; determining at least one popular listing amongst the plurality of listings located; generating metadata using the determined at least one popular listing and the plurality of user reviews to thereby facilitate the creation of a product data set for the product.

According to a broad aspect of the invention, there is provided a computer-readable storage medium storing computer-executable instructions which, when executed, cause a processing device to perform a method for facilitating the creation of a product data set for a product on a website, the method comprising providing an indication of the product; locating a plurality of listings offering at least one of the product and a similar product; locating a plurality of user reviews concerning at least one of the product and a similar product; determining at least one popular listing amongst the plurality of listings located; generating metadata using the determined at least one popular listings and the plurality of user reviews to thereby facilitate the creation of a product data set for the product.

According to a broad aspect of the invention, there is provided a computing device, the computing device comprising a display device; a central processing unit; a memory comprising a program, wherein the program is stored in the memory and configured to be executed by the central processing unit, the program comprising: instructions for providing an indication of the product; instructions for locating a plurality of listings offering at least one of the product and a similar product; instructions for locating a plurality of user reviews concerning at least one of the product and a similar product; instructions for determining at least one popular listing amongst the plurality of listings located; instructions for generating metadata using the determined at least one popular listings and the plurality of user reviews to thereby facilitate the creation of a product data set for the product.

An advantage of the method disclosed is that it facilitates the creation of a product data set by monitoring existing popular corresponding popular listings.

Another advantage of the method disclosed is that it takes advantage of existing listings for a given product as well as existing listings for similar products.

Another advantage of the method disclosed herein is that it takes into consideration popularity of listings for similar products.

According to a broad aspect of the invention, there is provided a method for facilitating the creation of a product data set for a product on a website, the method comprising use of a microprocessor for providing an indication of the product; locating a plurality of listings offering at least one of the product and a similar product; locating a plurality of user reviews concerning at least one of the product and a similar product; determining at least one popular listing amongst the plurality of listings located and generating metadata using the determined at least one popular listings and the plurality of user reviews to thereby facilitate the creation of a product data set for the product.

In accordance with an embodiment, the indication of the product is selected from a group consisting of a Universal Product Code (UPC), a Stock-Keeping Unit (SKU), a title and at least one keyword.

In accordance with an embodiment, the locating of a plurality of listings offering at least one of the product and a similar product comprises executing a headless browser, entering the indication of the product in a search field of the headless browser and obtaining corresponding results.

In accordance with an embodiment, the plurality of user reviews is located using a scraper.

In accordance with an embodiment, the determination of at least one popular listing comprises using at least one of a corresponding number of reviews for each of the plurality of listings located, a corresponding sentiment analysis for each of the plurality of listings located, a corresponding rating for each of the plurality of listings located and a corresponding price for a product corresponding to each of the plurality of listings located.

In accordance with an embodiment, the determination of at least one popular listing comprises using a click-through rate associated with each of the plurality of listings located.

In accordance with an embodiment, the determination of at least one popular listing comprises using one of a position associated with each of the plurality of listings located, a click-through rate associated with each of the plurality of listings located and a rating associated with each of the plurality of listing located.

In accordance with an embodiment, the generating of the metadata using the determined at least one popular listing and the plurality of user reviews comprises parsing the at least one popular listing and the plurality of user reviews and extracting a list of features for the product.

In accordance with an embodiment, the generating of the metadata using the determined at least one popular listing and the plurality of user reviews is performed using a natural language toolkit.

In accordance with an embodiment, the natural language toolkit uses product feature extraction, product sentiment analysis, product features sentiment analysis, product taxonomy, product comparison and similarity assessment, geo location, and gender analysis.

In accordance with an embodiment, the natural language toolkit uses Naive Bayes classifier, support vector machine, and logistic regression analysis.

In accordance with an embodiment, the natural language toolkit uses supervised learning approach, further wherein a training set is provided.

In accordance with an embodiment, the determining of at least one popular listing amongst the plurality of listings is performed for a defined group of at least one individual matching at least one criterion.

In accordance with an embodiment, the at least one criterion is selected from a group consisting of age of a user and location of the user.

In accordance with an embodiment, the method further comprises providing the generated metadata.

In accordance with an embodiment, the providing of the generated metadata comprises storing the generated metadata in a data file.

In accordance with an embodiment, the providing of the generated metadata comprises uploading at least one of the generated metadata in one of a webpage and an advertisement.

### BRIEF DESCRIPTION OF THE DRAWINGS

In order that the invention may be readily understood, embodiments of the invention are illustrated by way of example in the accompanying drawings.

FIG. 1 is a diagram which shows an embodiment of a system in which the method for facilitating the creation of a product data set for a product may be implemented.

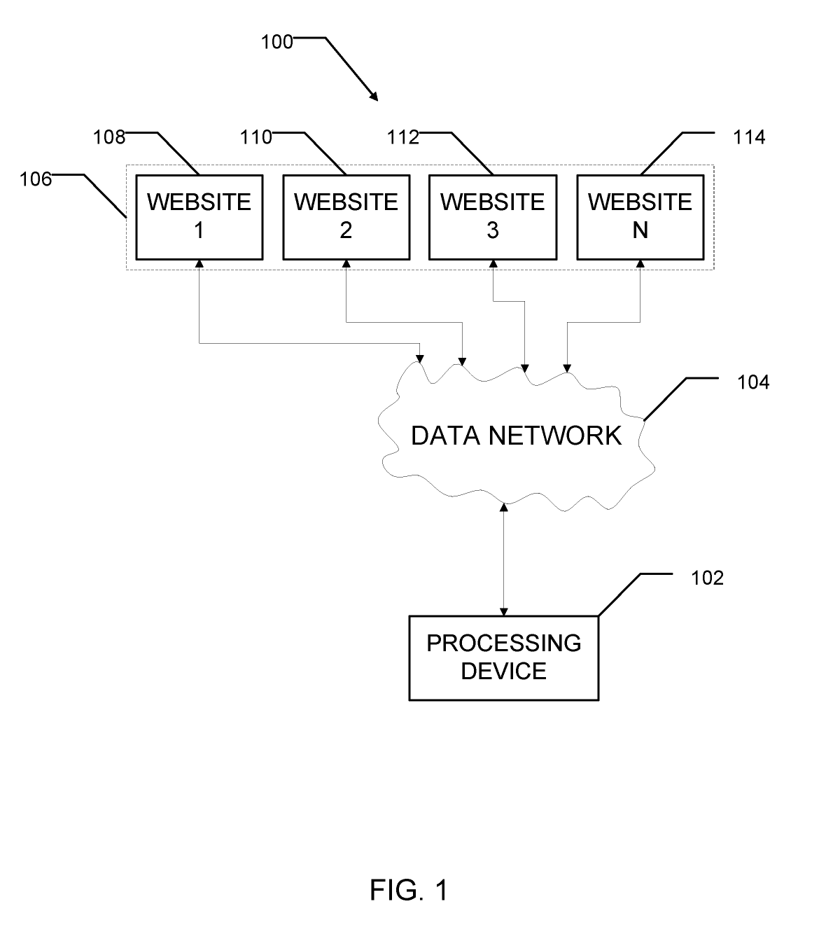

FIG. 2 is a flowchart which shows an embodiment of a method for facilitating the creation of a product data set for a product on a website.

FIG. 3 is a diagram of a computing device in which the method for facilitating the creation of a product data set for a product may be implemented.

Further details of the invention and its advantages will be apparent from the detailed description included below.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the term or phrase they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “respective” and like terms mean “taken individually.” Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is,” and thus limit the term or phrase they explain. For example, in the sentence “the computer sends data (i.e., instructions) over the Internet,” the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to,” the mere usage of the phrase “including but not limited to” does not mean that the term “including” means something other than “including but not limited to.”

The term “product” shall be given broad meaning in accordance with terminology of the art and includes (and be interchangeably referred to as) any good or service.

The term “product data set” shall be given broad meaning in accordance with terminology of the art and includes (and be interchangeably referred to as) product features.

The term “metadata” shall be given broad meaning in accordance with terminology of the art and includes data about a particular content and more precisely, data defining product features.

Various embodiments are described in the present application, and are presented for illustrative purposes only. The described embodiments are not, and are not intended to be, limiting in any sense. The presently disclosed invention(s) are widely applicable to numerous embodiments, as are readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

As disclosed below, the invention may be implemented in numerous ways, including as a method, an apparatus or a computer-readable medium such as a computer-readable storage medium.

With all this in mind, the present invention is directed to a method, a computer-readable storage medium and an apparatus for facilitating the creation of a product data set for a product on a website.

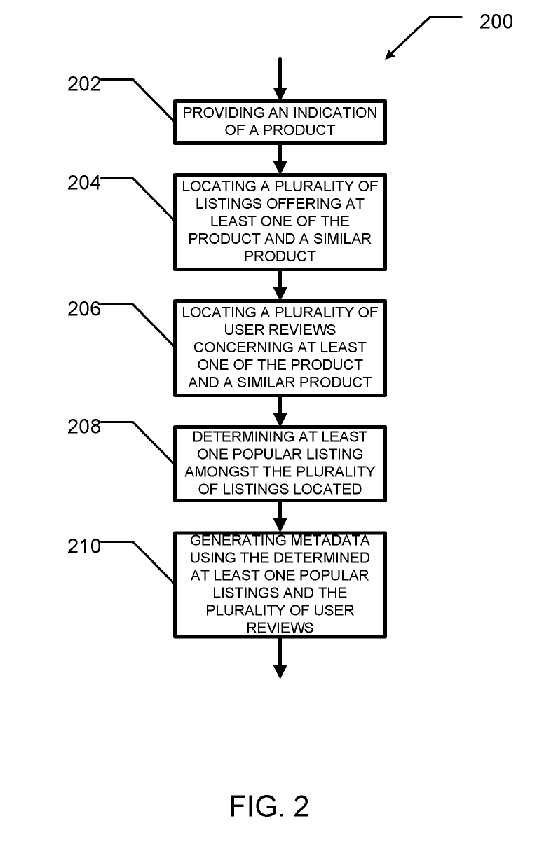

Now referring to FIG. 2, there is shown an embodiment of a method for facilitating the creation of a product data set for a product on a website.

According to processing step 202, an indication of a product is provided.

It will be appreciated that the indication of a product may be provided according to various embodiments.

In an embodiment, the indication of a product is provided by a user e.g., http://<host>:5000/job/scrapers?brands=casio&terms=baby.

In an alternative embodiment, the indication of a product is obtained from a dictionary of brands and Keywords e.g., http://<host>:5000/job/scrapers?brands=<brand>&terms=<keyword>. The skilled addressee will appreciated that the dictionary may be accessed locally or from a remote location via a data network for example. It will be appreciated that the dictionary may be accessed via a database.

Moreover, it will be appreciated that the indication of a product may be of various types.

For instance and in one embodiment, the indication of a product comprises a Universal Product Code (UPC).

In an alternative embodiment, the indication of a product comprises a Stock-Keeping Unit (SKU).

In a further alternative embodiment, the indication of a product comprises a title. An example of a title may be for instance “The North Face Vault Backpack Asphalt Grey/Zinc Grey.”

In a further alternative embodiment, the indication of a product comprises at least one keyword. An example of keywords may be for instance “shoes.”

According to processing step 204, a plurality of listings offering at least one of the product and a similar product are located.

It will be appreciated that the plurality of listings offering at least one of the product and a similar product are located according to various embodiments depending for instance on an indication of a product provided.

For instance and in the case where the indication of a product comprises a universal product code, a headless browser may be used. It will be appreciated that a headless browser is used when a simple scraping does not work or when it provides a limited list of results.

More precisely and in such embodiment, the universal product code is entered in the search field of the headless browser. It will be appreciated that the form is then submitted. It will be appreciated that the corresponding results are then provided on a new page, the search page.

It will be appreciated that alternatively the URL of the search page may be used directly. The returned results are a list of products.

In the case where the indication of a product comprises a stock-keeping unit, a headless browser may be used.

More precisely and in such embodiment, the stock-keeping unit is entered in the search field of the headless browser. The form is then submitted. It will be appreciated that the corresponding results are then provided on a new page, the search page.

It will be appreciated that alternatively the URL of the search page may be used directly. The returned results are a list of products.

In the case where the indication of a product comprises a product title, a headless browser may be further used.

More precisely and in such embodiment, the product title is entered in the search field of the headless browser. The form is then submitted. It will be appreciated that the corresponding results are then provided on a new page, the search page.

It will be appreciated that alternatively the URL of the search page may be used directly. The returned results are a list of products.

In the case where the indication of a product comprises at least one keyword, a headless browser may be used.

More precisely and in such embodiment, the at least one keyword is entered in the search field of the headless browser. The form is then submitted. It will be appreciated that the corresponding results are then provided on a new page, the search page.

It will be appreciated that alternatively the URL of the search page may be used directly. The returned results are a list of products.

According to processing step 206, a plurality of user reviews concerning at least one of the product and a similar product are located.

It will be appreciated that the plurality of user reviews concerning at least one of the product and a similar product may be located according to various embodiments.

In one embodiment, the plurality of user reviews are located using a scraper.

In one embodiment, the scraper is based on Scrapy (www.scrapy.org). It will be appreciated that the user reviews may be obtained via an application programming interface (API) (such as for instance http://developergoodguide.com/docs).

It will be also appreciated that the user reviews may originate from a social network such as Facebook™ or Instagram™, etc. As a matter of fact, specific data files such as pictures of products taken by users may be used as user reviews.

According to processing step 208, at least one popular listing is determined amongst the plurality of listings located.

It will be appreciated that the determination of the at least one popular listing may be performed according to various embodiments.

In fact, it will be appreciated that a popularity of a result page may be measured according to various embodiments.

In accordance with an embodiment, the determination of at least one popular listing comprises using a positioning associated with each of the plurality of listings located. Alternatively, a click-through rate associated with each listing of the plurality of listings may be used. The click-through rate may be readily available or alternatively it may be computed using a number of clicks on a given product and a number of access on a webpage hosting the given product.

In an alternative embodiment, popularity of a corresponding listing may be determined by checking at least one of a corresponding number of reviews, a corresponding sentiment analysis, a corresponding rating.

It will be appreciated that the rating includes computing an average rating using the various ratings provided by users on the result page, a corresponding price for the product in the result page and data such as a “gender,” an “age” of a reviewer.

Also it will be appreciated that the popularity of a given listing may be obtained for a defined group of individuals matching a specific criterion, such as an age range, a location, etc.

The skilled addressee will appreciate that alternative embodiments may be used for determining a popularity of a result page.

According to processing step 210, metadata are generated using the determined at least one popular listings and the plurality of user reviews.

In one embodiment, the generating of the corresponding metadata comprises parsing the at least one popular listings and the plurality of user reviews and extracting a list of features for the product.

It will be appreciated that a natural language toolkit may be used for performing such task in one embodiment.

It will be appreciated that the features of the natural language toolkit may include: product features extraction, sentiment analysis, product taxonomy, similarity comparison, geolocation, brand, product name and other named entity extraction, etc.

For instance with the following text:

Product description:

“With the Board Room Travel Mug you'll be able to keep your favorite hot or cold beverage with you and keep it hot or cold. This double-wall insulated travel mug will keep your hot drink hot, for up to two hours. It has a convenient (and distinctive) design and it will hold up to 16 ounces of your favorite beverage . . . .”

The natural language toolkit may be used to identify the following features: “Insulated travel mug,” “Guaranteed leak-proof,” “patented Perfect Drink lid,” “Stainless-steel outside and inside walls,” “Durable hand-washable leather-like accents,” “Keeps drinks hot for up to 2 hours.”

As mentioned, it will be appreciated that features may also be extracted from the user reviews using the natural language toolkit.

For instance, the following user review may be obtained:

“The best thing about this mug is the way it looks. I get compliments on it all the time; however, I purchased it hoping that it would hold up and do the job of keeping my coffee hot and be spill-proof. It has let me down on both counts . . . .”

It will be appreciated that the texts shown above are examples of usual kind of texts displayed on e-commerce websites, shopping channels, market places, etc.

It will be appreciated that the objective of the natural language toolkit is to analyze and extract features from those texts to help to optimize product placement, description and other features of product that help to stay competitive and increase the sales.

In this particular example, the natural language toolkit will determine that “Board Room Travel Mug” is the product name.

It will be able to extract the following features of that product: “keep hot or cold,” “double-wall insulated,” “travel mug,” “convenient and distinctive design,” “16 ounces.”

The natural language toolkit will also be able to detect the sentiments for each attribute (target) from user review and determine that “visual design” is the best feature and it has positive sentiment, whereas “not keeping coffee hot and spill-proof” is a negative review. Combining all other user reviews and possibly getting other data from different sources (such as for instance Twitter™, etc.) with data, mined about the competitors similar product and their user reviews, the commercial language toolkit will be able to suggest better alternatives for the representation of the product in question.

In an embodiment, the natural language toolkit is based on NLTK and scikit-learn python frameworks and implements the following characteristics:
product features extraction;
sentiment analysis for products and product features in one embodiment;
product taxonomy;
product comparison and similarity assessment; and
geolocation and other named entity extraction.

It will be appreciated that in machine learning there are two ways to create learning systems, i.e., supervised and unsupervised (there is also semi-supervised, in which very little data is available in the beginning and that data is used to bootstrap the unsupervised model).

In one embodiment, the natural language toolkit uses supervised learning approach, which requires having a training set, which must be labeled manually (or semi-automatically) and has to have meaningful features identified.

Features can be a frequency of words, parts of the speech, abbreviations, sequences of words, semantic connections, etc.

It will be appreciated that a most challenging part for having the most accurate model is to explore and understand what those features that best describe a problem are.

In fact, it is usually an iterative process and most useful features get discovered during the learning process as new data is gathered. It is possible to get statistical information on features to detect which are the most and least useful features so far.

It will be appreciated that there are a variety of machine learning algorithms that can be used to solve natural language related problems. Depending on the data size different methods are chosen to best solve the problems.

Naive Bayes, Support Vector Machine, Logistic Regression are best suited for this purpose.

More precisely, Naive Bayes will be effective on small data size, when gathering data has just started, because it is the “high-bias” algorithm. Once data grows, a switch to discriminative models such as Support Vector Machine or Logistic Regression models should be performed.

On large data, Naive Bayes comes back to rescue, since Support Vector Machine and Logistic Regression models become very slow and, in essence, once you have bid data all those models tend to give the same accuracy. The challenge here would be to identify the best possible feature-vectors.

Another challenge is to have methods to check and cross-validate the models to be sure false positives as well as other very hard to detect behaviors are not obtained.

As mentioned, it will be appreciated that the data is gathered from the e-commerce websites. It could be semi-structured or just a blob of text.

Then follows a text normalization, a stemming, a collocation retrieval, a tagging of part of the speech, a Named Entity Recognition, a Sequence classification, a computation of the Levenshtein distance for similarity assessment and a smoothing (Good-Turing or Kneser-Ney) for words there did not exist previously in the training set not to have 0 probability.

It will be appreciated that highly structured semantically linked information will be obtained after going through all these steps.

It will be appreciated that product features may then be determined. Moreover, sentiment analysis may also be performed as explained above. Also location names as well as brand names and other named entities may be further extracted.

The extracting may comprise obtaining for each of the list: title, description, brand, seller, buyURL, productURL, thumbnailURL, productImageURL.

According to processing step 212, the corresponding metadata is provided.

It will be appreciated that the corresponding metadata may be provided according to various embodiments.

In one embodiment, at least one of the corresponding metadata is stored in a data file. For instance, the at least one of the corresponding metadata may be stored in a database, such as SQL database system.

In fact and in one embodiment, it will be appreciated that the corresponding at least one metadata may be used for the creation of a product data set for the product. In such embodiment, the providing of the generated metadata comprises uploading at least one of the generated metadata in one of a webpage and an advertisement.

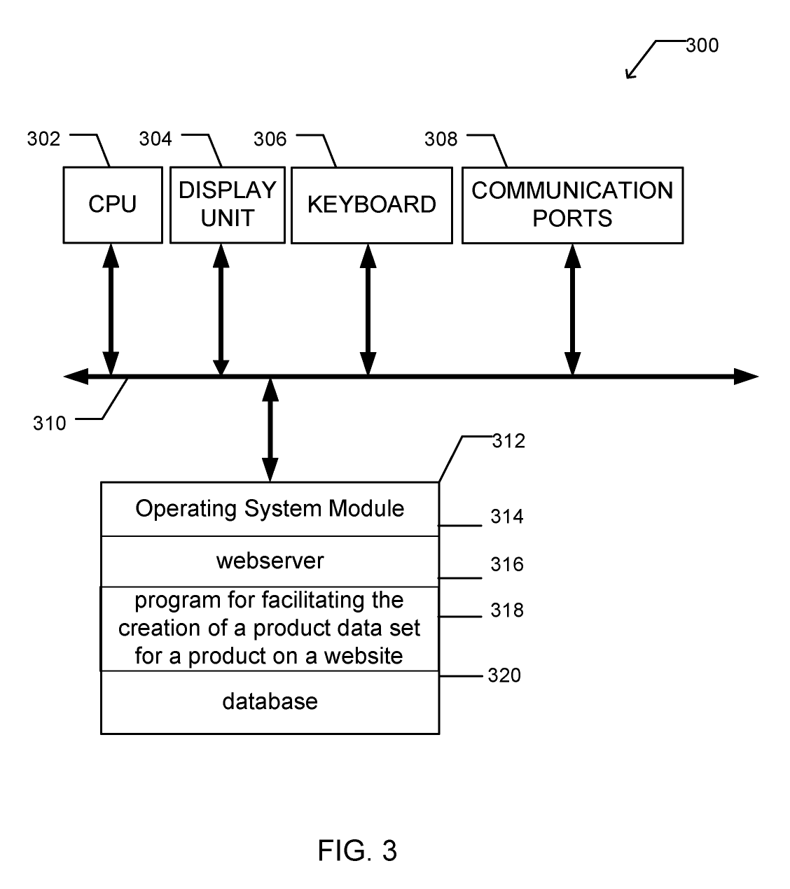

Now referring to FIG. 3, there is shown an embodiment of a processing device 300 which may be used for implementing the method for facilitating the creation of a product data set for a product on a website.

The processing device 300, also referred to as a computer or a computing device comprises a Central Processing Unit (CPU) 302, a display unit 304, a keyboard 306, communication ports 308, a data bus 310 and a memory 312.

The Central Processing Unit 302, the display unit 304, the keyboard 306 and the memory 312 are connected together using the data bus 310.

In one embodiment, the computer 300 is a server provided on Amazon Web Services.

Still in this embodiment, the display unit 304 is a standard display unit.

The communication ports 308 are used for enabling the computer 300 to share data with other processing devices. Examples of other processing devices comprise a processing device of a customer, a processing device of a client, etc.

The memory 312 is used for storing data.

More precisely and still in this embodiment, the memory 312 comprises, inter alia, an operating system module 314.

In one embodiment, the operating system module 314 is Linux.

The memory 312 further comprises a communication program 316. In one embodiment, the communication program 316 is used for providing the corresponding metadata associated with the at least one of the product to a third party.

The memory 312 further comprises a program for facilitating the creation of a product data set for a product on a website 318.

The memory further comprises a database 320 for storing data.

More precisely, the program for facilitating the creation of a product data set for a product on a website 318 comprises instructions for providing an indication of the product.

The program for facilitating the creation of a product data set for a product on a website 318 further comprises instructions for locating a plurality of listings offering at least one of the product and a similar product.

The program for facilitating the creation of a product data set for a product on a website 318 further comprises instructions for locating a plurality of user reviews concerning at least one of the product and a similar product.

The program for facilitating the creation of a product data set for a product on a website 318 further comprises instructions for determining at least one popular listing amongst the plurality of listings located.

The program for facilitating the creation of a product data set for a product on a website 318 further comprises instructions for generating metadata using the determined at least one popular listings and the plurality of user reviews to thereby facilitate the creation of a product data set for the product instructions for receiving an indication of the product.

It will be appreciated that a computer-readable storage medium may be provided for storing computer-executable instructions. Such computer-executable instructions, when executed, would cause a processing device to perform a method for facilitating the creation of a product data set for a product on a website, the method comprising providing an indication of the product; locating a plurality of listings offering at least one of the product and a similar product; locating a plurality of user reviews concerning at least one of the product and a similar product; determining at least one popular listing amongst the plurality of listings located and generating metadata using the determined at least one popular listings and the plurality of user reviews to thereby facilitate the creation of a product data set for the product.

1. A method for facilitating the creation of a product data set for a product on a website, the method comprising:
use of a microprocessor for:
providing an indication of the product;
locating a plurality of listings offering at least one of the product and a similar product;
locating a plurality of user reviews concerning at least one of the product and a similar product;
determining at least one popular listing amongst the plurality of listings located;
generating metadata using the determined at least one popular listings and the plurality of user reviews to thereby facilitate the creation of a product data set for the product.

2. The method as claimed in claim 1, wherein the indication of the product is selected from a group consisting of a Universal Product Code (UPC), a Stock-Keeping Unit (SKU), a title and at least one keyword.

3. The method as claimed in claim 1, wherein the locating of a plurality of listings offering at least one of the product and a similar product comprises executing a headless browser, entering the indication of the product in a search field of the headless browser and obtaining corresponding results.

4. The method as claimed in claim 1, wherein the plurality of user reviews is located using a scraper.

5. The method as claimed in claim 1, wherein the determination of at least one popular listing comprises using at least one of a corresponding number of reviews for each of the plurality of listings located, a corresponding sentiment analysis for each of the plurality of listings located, a corresponding rating for each of the plurality of listings located and a corresponding price for a product corresponding to each of the plurality of listings located.

6. The method as claimed in claim 1, wherein the determination of at least one popular listing comprises using one of a position associated with each of the plurality of listings located, a click-through rate associated with each of the plurality of listings located and a rating associated with each of the plurality of listing located.

7. The method as claimed in claim 1, wherein the generating of the metadata using the determined at least one popular listing and the plurality of user reviews comprises parsing the at least one popular listing and the plurality of user reviews and extracting a list of features for the product.

8. The method as claimed in claim 1, wherein the generating of the metadata using the determined at least one popular listing and the plurality of user reviews is performed using a natural language toolkit.

9. The method as claimed in claim 8, wherein the natural language toolkit uses product feature extraction, product sentiment analysis, product features sentiment analysis, product taxonomy, product comparison and similarity assessment, and geolocation.

10. The method as claimed in claim 8, wherein the natural language toolkit uses Naive Bayes classifier, support vector machine, and logistic regression analysis.

11. The method as claimed in claim 8, wherein the natural language toolkit uses supervised learning approach, further wherein a training set is provided.

12. The method as claimed in claim 1, wherein the determining of at least one popular listing amongst the plurality of listings is performed for a defined group of at least one individual matching at least one criterion.

13. The method as claimed in claim 12, wherein the at least one criterion is selected from a group consisting of age of a user and location of the user.

14. The method as claimed in claim 1, further comprising providing the generated metadata.

15. The method as claimed in claim 14, wherein the providing of the generated metadata comprises storing the generated metadata in a data file.

16. The method as claimed in claim 14, wherein the providing of the generated metadata comprises uploading at least one of the generated metadata in one of a webpage and an advertisement.

17. A computer-readable storage medium storing computer-executable instructions which, when executed, cause a processing device to perform a method for facilitating the creation of a product data set for a product on a website, the method comprising:
providing an indication of the product;
locating a plurality of listings offering at least one of the product and a similar product;
locating a plurality of user reviews concerning at least one of the product and a similar product;
determining at least one popular listing amongst the plurality of listings located;
generating metadata using the determined at least one popular listings and the plurality of user reviews to thereby facilitate the creation of a product data set for the product.

18. A computing device, the computing device comprising:
a display device;
a central processing unit;
a memory comprising a program, wherein the program is stored in the memory and configured to be executed by the central processing unit, the program comprising:
instructions for providing an indication of the product;
instructions for locating a plurality of listings offering at least one of the product and a similar product;
instructions for locating a plurality of user reviews concerning at least one of the product and a similar product;
instructions for determining at least one popular listing amongst the plurality of listings located;
instructions for generating metadata using the determined at least one popular listings and the plurality of user reviews to thereby facilitate the creation of a product data set for the product.
